(19) United States
(12) Patent Application Publication
(10) Pub. No.: US 2022/0090810 A1
(43) Pub. Date: Mar. 24, 2022

(54) SYSTEMS AND METHODS FOR VERIFYING THE PERFORMANCE OF INSTALLED AIR VENTILATION SYSTEMS

(71) Applicant: Broan-NuTone LLC, Hartford, WI (US)

(72) Inventors: John Nurse, Hartford, WI (US); Eric Theriault, Hartford, WI (US); Richard R. Sinur, Hartford, WI (US); Jason Asmus, Hartford, WI (US); Brian Madson, Hartford, WI (US); Taylor Schroeder, Hartford, WI (US); Robert G. Penlesky, Hartford, WI (US)

(21) Appl. No.: 17/425,417

(22) PCT Filed: Feb. 11, 2020
(86) PCT No.: PCT/US20/17758

§ 371 Date: Jul. 23, 2021

Related U.S. Application Data
(60) Provisional application No. 62/803,966, filed on Feb. 11, 2019.

(51) Int. Cl. F24F 11/526; F24F 7/007; F24F 11/38; F24F 11/57; F24F 11/88

(52) U.S. Cl. CPC F24F 11/526; F24F 7/007; F24F 11/88; F24F 11/57; F24F 11/38

(57) ABSTRACT

The present disclosure provides a system and method for self-determining and verifying the operating performance of installed air ventilation systems. More particularly, the present disclosure relates to a system and method for self-determining operating parameters, such as air flow rate and/or sound levels, of an installed air ventilation system, and then verifying compliance of the determined operating parameter with operating and performance standards set by local or state authorities, or other regulatory bodies, for presentment to a user. If there is no compliance with the operating and performance standards, then the user can take remedial measures in a prompt and efficient manner. The installed air ventilation system can be a bathroom exhaust fan, or a kitchen ventilation hood installed above a cooktop or range.

### PRIORITY CLAIM

This application claims priority under 35 U.S.C. § 119(e) to PCT Application Serial No. US2020/17758, filed Feb. 11, 2020 and U.S. Provisional Application Ser. No. 62/803,966, filed Feb. 11, 2019, the disclosure of which is expressly incorporated by reference herein in its entirety.

### TECHNICAL FIELD

The present disclosure relates to a system and method for self-determining and verifying the performance of installed air ventilation systems. More particularly, the present disclosure relates to a system and method for self-determining and verifying the flow rate of an air ventilation system, such as an installed bathroom exhaust fan, cooktop/range ventilation hood, heat-recovery ventilator (HRV), energy-recovery ventilator (ERV), or supply fan, for compliance with operating and performance standards set by local or state authorities, or other regulatory bodies.

### BACKGROUND

Conventional ventilation exhaust fans installed in a room of a building structure, such as a bathroom, draw air from within an area of the room, through the fan, and exhaust the air to another location through a discharge outlet, such as a vent formed in in the gable or roof of the building structure. Operating and performance standards set by local or state authorities, or other regulatory bodies require installed ventilation exhaust fans to meet certain performance criteria, such as a minimum flow rate through the fan. Typically, the flow rate of the exhaust fan is not tested until the building structure construction project is completed or nearly completed and an inspector arrives to inspect and verify the performance of the various building systems. If the exhaust fan fails that inspection process, then remediation is required. This remediation can involve adjusting the already-installed ventilation exhaust fan or replacing it with a different ventilation exhaust fan. These activities cost valuable time and resources in replacing or re-working the installation of the ventilation exhaust fan, including potentially enlarging or reducing discharge outlets or opening and closing adjacent walls and other structures.

Therefore, a need exists for an integrated system that can verify performance of an installed ventilation exhaust fan early in the construction process and prior to a later inspection phase. A full discussion of the features and advantages of the present disclosure is deferred to the following Detailed Description section, which includes reference to the accompanying drawings.

The description provided in the background section should not be assumed to be prior art merely because it is mentioned in or associated with the background section. The background section may include information that describes one or more aspects of the subject technology.

### SUMMARY

A ventilation system in accordance with the present disclosure may include a ventilation fan adapted to be installed to a support surface in a room of a building and a test unit operatively coupled to the ventilation fan. The ventilation system may self-determine its operating characteristics to allow a user to assess compliance of the ventilation system with pre-determined performance standards. The ventilation fan may be operable to draw air from the room to a discharge location external to the room. The test unit may (i) measure operating characteristics of the ventilation fan to determine a flow rate of the ventilation fan, and (ii) provide a signal to the user regarding the determined flow rate in comparison to the performance standards.

In illustrative embodiments, the test unit may be operatively coupled to a motor of the ventilation fan. The test unit may measure at least one of a rotational speed of the motor and a current draw of the motor during operation of the ventilation fan for determining the flow rate of the ventilation fan.

In illustrative embodiments, the test unit may be configured to provide at least one of a visual and auditory signal regarding the determined flow rate of the ventilation fan.

In illustrative embodiments, the test unit may be configured to (i) produce light in a first visible color in response to the determined flow rate being above a threshold value of the performance standards and (ii) to produce light in a second visible color in response to the determined flow rate being below the threshold value of the performance standards.

In illustrative embodiments, an outlet display module of the test unit may include a plurality of indicators configured to produce visible light. Each indicator may represent a digit of a numerical value. The test unit may be configured to blink the indicators to visually indicate a numerical value of the flow rate to a user.

In illustrative embodiments, the test unit may be configured to wirelessly connect with a mobile electronic device for display of the determined flow rate.

A method for operating a ventilation system in accordance with the present disclosure may include providing a ventilation fan having a test unit, installing the ventilation fan to a support surface in a room of a building, and operating the ventilation fan to draw air from the room to a discharge location external to the room. The ventilation system may self-determine its operating characteristics to allow a user to assess compliance of the ventilation system with pre-determined performance standards. The method may further include measuring operating characteristics of the ventilation fan with the test unit to determine a flow rate of the ventilation fan, comparing the determined flow rate against a threshold value of the pre-determined performance standards with the test unit, and displaying a signal to the user of the ventilation system regarding the determined flow rate as compared to the threshold value of the pre-determined performance standards.

In illustrative embodiments, the method may further include displaying a first signal in response to the determined flow rate being above the threshold value and displaying a second signal in response to the determined flow rate being below the threshold value.

In illustrative embodiments, the method may further include blinking a plurality of indicators to visually indicate a numerical value of the flow rate to a user. Each indicator may represent a digit of the numerical value.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a diagrammatic view of one embodiment of an exemplary ventilation system in accordance with the present disclosure showing that the ventilation system includes a ventilation fan positioned to exhaust air from an indoor room environment and a test unit associated with the ventilation fan for determining and verifying the operating performance of the ventilation fan;

FIG. 2 is a flow chart of one embodiment of an exemplary process for operating the ventilation system to determine and verify the operating performance of the ventilation fan;

FIG. 3 is a perspective view of the ventilation system of FIG. 1 illustrating a process step of verifying the operating performance of the installed ventilation fan, including determining its flow rate and providing a signal to a user;

FIG. 4 is a diagrammatic view illustrating another exemplary process in accordance with the present disclosure for providing a signal to a user regarding the determined flow rate of the ventilation fan;

FIG. 5 is a perspective view of the ventilation system illustrating a process step of providing a signal to a user's mobile electronic device regarding the determined flow rate of the ventilation fan;

FIG. 6 is a diagrammatic view of one embodiment of a circuit of an exemplary test unit of the ventilation system in accordance with the present disclosure;

FIG. 7 is a flow chart of an exemplary process in accordance with the present disclosure for operating the ventilation system, showing steps for Initialization and Status Check processes;

FIG. 8 is a flow chart showing steps for a Data Collection process in accordance with the present disclosure;

FIG. 9 is a flow chart showing steps for a CFM Data Output process in accordance with the present disclosure;

FIG. 10 is a flow chart diagram showing steps for a Sleep Mode process in accordance with the present disclosure;

FIG. 11 is a flow chart diagram showing steps for a Communication Error Signaling process in accordance with the present disclosure; and,

FIG. 12 is a flow chart diagram showing steps for a Fan Operational Error Signaling process in accordance with the present disclosure.

In one or more implementations, not all of the depicted components in each figure may be required, and one or more implementations may include additional components not shown in a figure. Variations in the arrangement and type of the components may be made without departing from the scope of the present disclosure. Additional components, different components, or fewer components may be utilized within the scope of the present disclosure.

### DETAILED DESCRIPTION

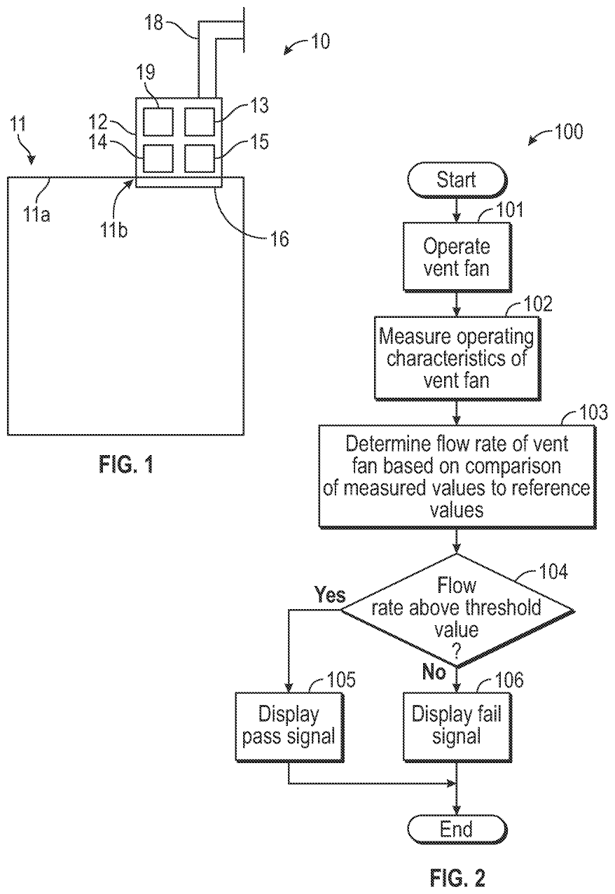

One embodiment of a ventilation system 10 in accordance with the present disclosure is shown in FIG. 1. The ventilation system 10 includes a ventilation fan 12 (sometimes called a ventilation exhaust fan or “vent fan” in the Figures) and a test unit 14 (sometimes called a test module) operatively coupled to the ventilation fan 12 for measuring and self-determining operating performance characteristics of the ventilation fan 12, without the use of external devices such as an air flow meter. The test unit 14 verifies performance of the ventilation fan 12 from the measured operating performance characteristics in comparison to threshold values, such as those provided in building and/or operating performance standards set by local or state authorities, or other regulatory bodies. The steps of measuring and verifying the operating performance characteristics of the ventilation fan 12 occurs with the ventilation fan 12 installed to a support surface (e.g., at least one ceiling joist) within a building structure (e.g., installed within a bathroom of a home or office building). The test unit 14 determines a flow rate through the ventilation fan 12 and provides a signal to a “User” regarding the flow rate of the ventilation fan 12 as further described herein. If there is no compliance with the operating and performance standards, then the User can take remedial measures in a prompt and efficient manner. As discussed below, the “User” includes the installer of the ventilation system 10, an inspector who checks and verifies the performance of the ventilation system 10 during the building inspection process, a technician who verifies and potentially adjusts the performance of the ventilation system 10 subsequent to installation and inspection. In some instances, the User can also include a person, such as a homeowner or property manager, who observes and potentially adjusts the performance of the ventilation system 10 over time.

In the embodiment shown in FIG. 1, the ventilation fan 12 is positioned to vent air from an indoor environment or room 11, such as a bathroom for example, through a duct 18 to a discharge location, such as an external environment beyond the room 11. The ventilation fan 12 is affixed to a support surface, such as the ceiling 11a of the room 11 and is aligned with an aperture 11b formed in the ceiling 11a. A vent cover 16, such as a grille cover or guard cover with at least one aperture can be cooperatively positioned to underlie the ventilation fan 12 (i.e. vertically below the installed fan 12) and obscure the ceiling aperture 11b such that neither the fan 12 nor the aperture 11b are plainly visible to the User standing in the room 11. The ventilation fan 12 includes a motor 13 and a fan element 15, such as an impeller, coupled to the motor 13. The motor 13 rotates the fan element 15 to draw air from the room 11 through the fan 12 and into the duct 18 for discharge. In some embodiments, the motor 13 is a brushless DC (BLDC) motor. In some embodiments, the test unit 14 can be integrated with the ventilation fan 12. In some embodiments, the test unit 14 is integrated into a control unit 19 or in communication with the control unit 19 of the ventilation fan 12 used to operate the ventilation fan 12. In some embodiments, the ventilation fan 12 is part of a kitchen range hood or cooktop exhaust system, a heat-recovery ventilator (HRV), energy-recovery ventilator (ERV), or a supply fan that provides air, typically from an external source, to a ventilation system.

Many building codes and regulations, and other certifications such as EnergySTAR, LEED, and other “green” building programs, require ventilation fans to operate and perform with a flow rate above a specified performance level. See for example Canada's National building codes, including 9.32.3.4-9.32.3.5, and CAN/CSA-F326-M91). Stricter local codes and performance standards may have been adopted or may be adopted in the future (e.g., State of California Title 24). The configuration of the duct 18, including its diameter, length, and layout, can affect the ability of air to travel through the duct 18. For example, a first duct 18 that includes one or more curved segments (often referred to as “elbows”) will affect performance of the fan 12 differently than a second duct 18 having only straight or linear segments. The relevant codes/regulations/certifications may require the ventilation fan 12 to perform at specified levels wherein the fan 12 provides a specific minimum flow rate of air through duct 18 in view of its configuration, as provided by the duct's diameter, length, and layout. The ventilation system 10 of the present disclosure allows the User, such as an installer of the ventilation system 10, to verify the performance of the ventilation fan 12 for compliance with applicable building codes and regulations. The ventilation system 10, including the test unit 14, can be utilized to determine the flow rate consistent with Section 100.0(h) of California's Building Energy Efficiency Standards (Title 24, Part 6). For example, an installer can determine the flow rate of the ventilation fan 12 with the test unit 14 upon installation of the ventilation system 10 to allow for adjustments to be made if the flow rate does not meet the applicable building codes and regulations. Such adjustments can include changes to the configuration of the duct 18, including its diameter, length, and layout, the termination fittings or the ventilators. Advantageously, these adjustments can be made before finishing and cosmetic work, such as drywall installation and painting, is completed which makes access to the ventilation fan 12 and the duct 18 more difficult. This also saves time and money by avoiding repeat installation work, including work in opening and patching the surrounding wall and/or ceiling areas, after inspection by a building inspector for compliance with the applicable building codes and regulations. The ventilation system 10 can also allow for diagnosis of poor performance of the system 10, namely the fan 12, during later service and/or repair visits by a technician.

One illustrative process 100 for operating the ventilation system 10 is shown in FIG. 2. The process 100 starts with an operation 101 to power-on and operate the ventilation fan 12 under normal conditions. The test unit 14 measures operating characteristics of the ventilation fan 12 in a measurement operation 102. In some embodiments, the measured operating characteristics include a rotational speed (e.g., revolutions per minute (RPM)) and current draw (e.g., amperage (amps)) of the motor 13 of the ventilation fan 12. A determination operation 103 uses the measurements taken in the measurement operation 102 to determine the flow rate of the ventilation fan 12. In some embodiments, a measurement of high RPM and low amperage of the motor 13 indicates a low flow rate (e.g., in cubic feet per minute (CFM)) through the ventilation fan 12, which further reflects “no load” condition. In some embodiments, the CFM of the ventilation fan 12 can be determined through a comparison of the measured values with a predetermined calibration model correlating amperage and RPM of the motor 13 with CFM of the ventilation fan 12. In some embodiments, only one of RPM and amperage are used in calculating the flow rate. In some embodiments, at least one of RPM, current draw, and other operating characteristics is used to calculate the flow rate. In some embodiments, the determination of CFM is completed by the test unit 14. In some embodiments, the determination of CFM is completed by another device connected wired/wirelessly to the test unit 14 using the measurements gathered by the test unit 14. A “pass” signal is displayed to the User if the determined flow rate is above a threshold value, such as a flow rate identified in the applicable building codes and/or performance regulations, in operations 104 and 105. A “fail” signal is displayed to the User if the determined flow rate is below the threshold value in operations 104 and 106. The pass and fail signals indicate to the User whether additional work is needed for installing or adjusting the ventilation system 10. In some embodiments, the threshold value can be pre-set during the manufacture of the system 10 or input by the User prior to or during installation of the system 10. In the event that the building codes and/or performance regulations are updated or revised subsequent to installation of the system 10, for example, with a new threshold value(s) then the User can upload the new threshold value(s) into the MCU 31 via the wireless transmitter/receiver 26 of the circuit 30 of the test unit 14, as those components are discussed below. The process 100 concludes after the pass or fail signal is displayed. In some embodiments, the process 100 is initiated each time the ventilation fan 12 is operated, such as by activating a connected switch. In some embodiments, the process 100 is initiated through a switch of the test unit 14 (not shown in FIG. 1).

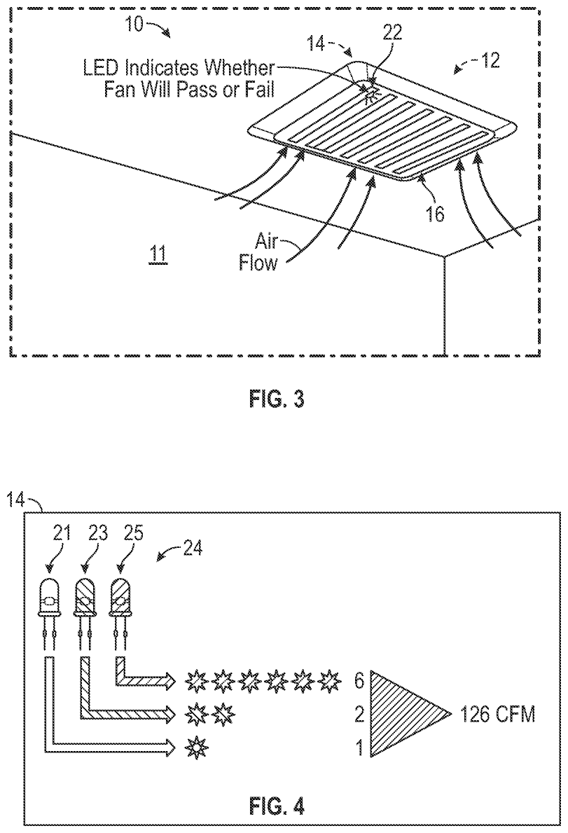

In one illustrative embodiment, an indicator 22, such as a light-emitting diode (LED), bulb, lamp, or other light-emitting device, of the test unit 14 produces light in a first visible color, such as green, to provide the pass signal to the User as suggested in FIG. 3. A green LED can be activated when the fan 12 is operating at/above a threshold value. In some embodiments, a dip switch setting controls activation of the LED. In some embodiments, the LED drive and logic can be integrated into a separate module. The indicator 22 produces light in a second visible color, such as red, for the fail signal. In some embodiments, the indicator 22 can illuminate and darken (i.e., blink) to provide further information to the User. For example, a rapidly blinking red indicator 22 can signal to the User that the flow rate of the ventilation fan 12 is significantly below the threshold value (e.g., more than 10% below), and a slowly blinking red indicator 22 can signal to the User that the flow rate of the ventilation fan 12 is marginally below the threshold value (e.g., less than 10% below). In the illustrative embodiment, the indicator is visible through the vent cover 16. In some embodiments, the indicator 22 is positioned at an exterior of the vent cover 16, such as being integrated into the flange of the cover 16. In some embodiments, auditory signals, such as “beeps”, chimes, simulated speech, or other sounds, are provided to the User with information from the test unit 14 in addition or alternative to visual signals from the indicator 22. In some embodiments, the indicator 22 is integrated with the motor 13 or other component of the ventilation fan 12.

In another illustrative embodiment, an output display module 24, such as a meter, of the test unit 14 includes a plurality of indicators 21, 23, 25, such as LED lights of various color, as suggested in FIG. 4. The indicators 21, 23, 25 can represent digits of a number representing the flow rate of the ventilation fan 12 for display to the User. In the illustrative embodiment, the indicator 21 represents a 100's place, the indicator 23 represents a 10's place, and the indicator 25 represents a 1's place in the displayed number. The flow rate number displayed to the User can be based on the number of times the indicator 21, 23, 25 is illuminated and darkened (i.e., blinked). For example, a single blink of the indicator 21, two blinks of the indicator 23, and six blinks of the indicator 25 indicates a reading of 126 CFM for the ventilation fan 12. It should be understood that more or less indicators can be used without departing from the present disclosure. In some embodiments, the blinking pattern repeats for a period of time. In some embodiments, auditory signals, such as “beeps”, chimes, simulated speech, or other sounds, are provided to the User with information from the test unit 14 in addition or alternative to visual signals from the indicator 22.

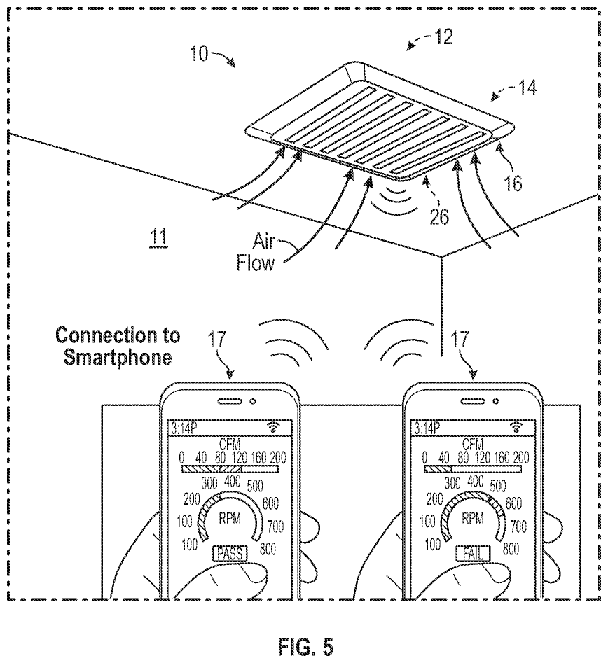

In another illustrative embodiment, a wireless transmitter/receiver 26 of the test unit 14 allows a mobile electronic device 17, such as a smartphone, tablet, or computer, to wirelessly connect with the test unit 14 as suggested in FIG. 5. The electronic test unit 14 could communicate over Bluetooth, Wi-Fi, or other wireless frequency to a connected device and display the readings via an app/software GUI. In the illustrative embodiment, information collected by the test unit 14, such as the measured RPM of the motor 13, determined CFM of the ventilation fan 12, and pass or fail signal, among other information, can be transmitted to the mobile electronic device 17 for display to and evaluation by the User. In some embodiments, the process 100 can be initiated by the mobile electronic device 17.

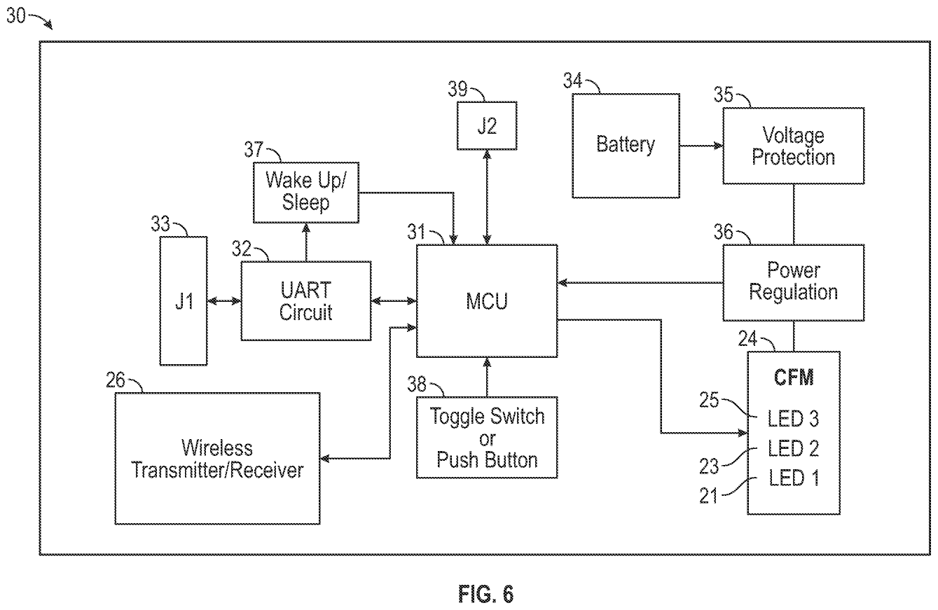

One embodiment of a circuit 30 for use in the test unit 14 is shown in FIG. 6. The circuit 30 includes a microcontroller unit (MCU) 31, a universal asynchronous transmitter-receiver (UART) circuit 32 operatively coupled to the MCU 31, and a connector 33 operatively coupled to the UART circuit 32. The connector 33 and the UART circuit 32 allow the test unit 14 to connect with the motor 13 and/or a controller of the motor 13, via a communication protocol, to gather measurements of the operating characteristics of the motor 13 as detailed herein. One embodiment of a Remote Motor Interface (RMI) Setup Protocol for use in connection and communication between the circuit 30 and the motor 13 is provided near the end of this Section. In the illustrative embodiment, a battery 34 is operatively coupled to an optional voltage protection module 35 and a power regulation module 36 to provide power to the circuit 30. In some embodiments, the test unit 14 and the circuit 30 are coupled to a power supply of the room 11 in addition or alternatively to the battery 34. In some embodiments, the test unit 14 and circuit 30 receive power from the motor 13 or another component of the ventilation fan 12 and/or the battery 34.

In one illustrative embodiment, the output display module 24 is operatively connected to the MCU 31 and the power regulation module 36 as shown in FIG. 6. The MCU 31 operates the output display module 24 to provide the signal to the User regarding the flow rate of the ventilation fan 12 as detailed herein. In some embodiments, the wireless transmitter/receiver 26 is operatively coupled to the MCU 31 and/or the output display module 24 to allow the test unit 14 to connect with mobile electronic devices 17, as detailed herein. In some embodiments, a supplemental power supply (not shown) is operatively coupled to the wireless transmitter/receiver 26. In some embodiments, a connector 39 allows the User to directly connect a mobile electronic device, such as an electronic reader, smartphone, tablet or computer, to circuit 30 for diagnostics or other functions, including signaling the MCU 31 to begin one or more processes for measuring the operating characteristics of the motor 13 as detailed herein.

In one illustrative embodiment, a wake up/sleep module 37 is operatively coupled to the UART circuit 32 and the MCU 31 as shown in FIG. 6. The wake up/sleep module 37 detects activation of the motor 13 and provides a signal to the MCU 31 to begin one or more processes for measuring the operating characteristics of the motor 13, as detailed herein. In some embodiments, a switch 38, such as a toggle switch or push button, is operatively coupled to the MCU 31 in addition or alternative to wake up/sleep module 37. The switch 38 allows the User to activate the test unit 14 and/or provide a signal to the MCU 31 to begin one or more processes for measuring the operating characteristics of the motor 13 as detailed herein.

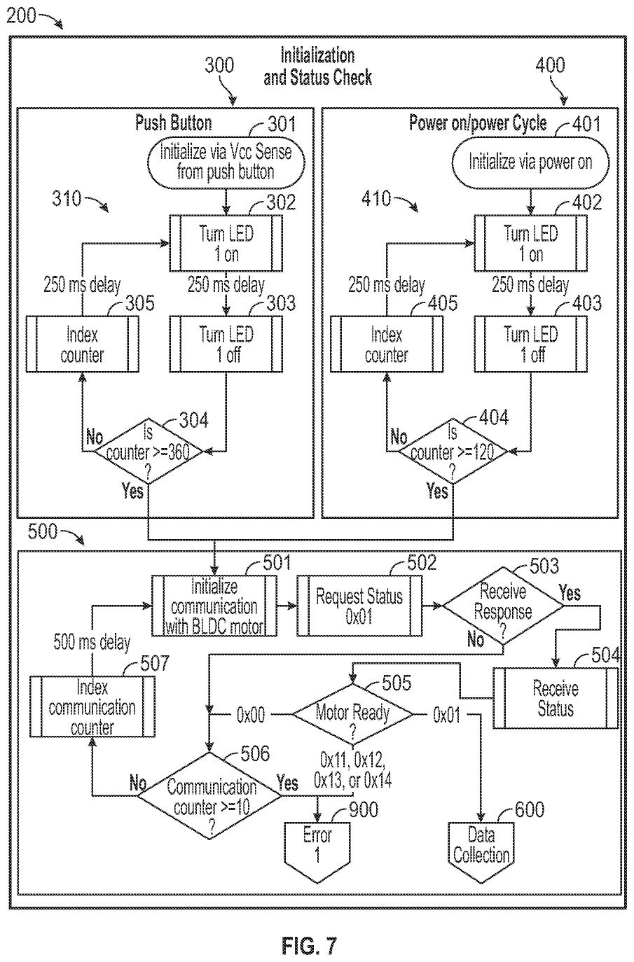

Another illustrative process 200 for operating the ventilation system 10 is shown in FIGS. 7-12. In the illustrative embodiment, the operating process 200 starts with one of two alternative initialization processes 300, 400 as shown in FIG. 7. In some embodiments, only one of the initialization processes 300, 400 is used. In the initialization process 300, a user engages the switch 38 in an operation 301 to initiate a wait cycle 310. The wait cycle 310 provides a brief time delay and signals to the User that the process 200 is initializing through operations 302-305 shown in FIG. 7. A status check process 500 begins after a predetermined number of cycles through the wait cycle 310. Alternatively, the initialization process 400 begins when it is sensed by the wake up/sleep module 37 that the motor 13 of the ventilation fan 12 is powered on in an operation 401 and starts the wait cycle 410. The wait cycle 410 provides a brief time delay and signals to the User that the process 200 is initializing through operations 402-405 shown in FIG. 7. The status check process 500 begins after a predetermined number of cycles through the wait cycle 410.

Further referring to FIG. 7, the status check process 500 starts with an operation 501 to initialize communication with the motor 13 or a controller of the motor 13. A status of the motor 13 is requested in an operation 502, and a communication counter is advanced if no response is received in operations 503, 506, 507 and the operations 501, 502 are then repeated. An error signaling process 900 is initiated if the communication counter reaches a predetermined number. A status of the motor 13 is received in an operation 504 if a response is successfully received in the operation 503. A status of the motor 13 is determined in an operation 505, and the communication counter is advanced in the operation 506, the error signaling process 900 is initiated, or a data collection process 600 is initiated depending on the status of the motor 13. In some embodiments, codes 0x11, 0x12, 0x13, 0x14 represent pre-programmed error codes indicating one or more errors in the ability to communicate with and/or collect data from the motor 13, among other errors. In some embodiments, code 0x00 indicates that the motor 13 is off and not operating. In some embodiments, code 0x01 indicates that the motor 13 is operating.

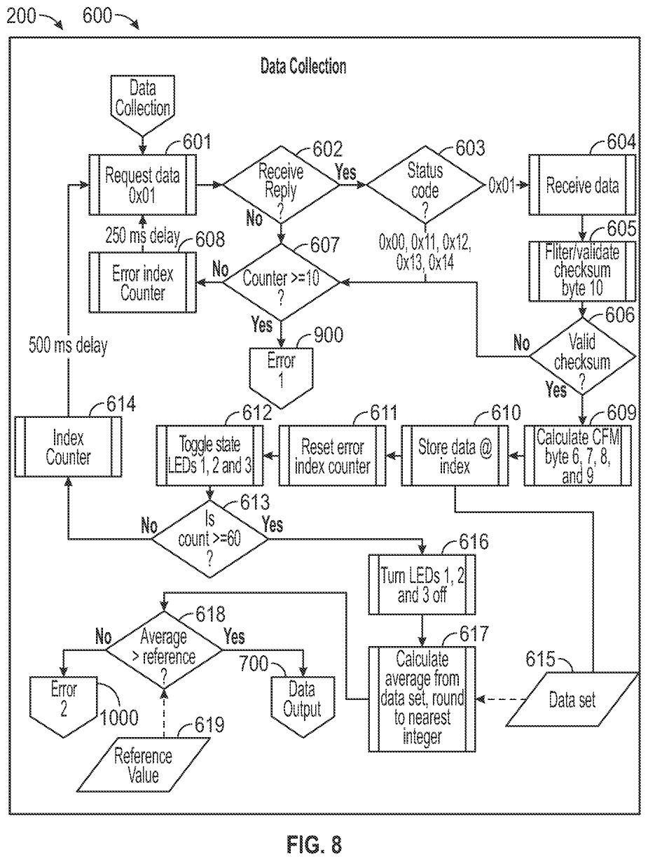

FIG. 8 shows an illustrative embodiment of the data collection process 600 of the ventilations system operating process 200. The data collection process 600 starts with a data request operation 601. An error counter is advanced in operations 607, 608 if no reply is received in an operation 602. The error signaling process 900 is initiated if the error counter reaches a predetermined number. A status code check is conducted in an operation 603, and the error counter is advanced in the operations 607, 608 or data is received in an operation 604 depending on the received status code. A checksum validation is conducted in operation 605, 606 of the data received in the operation 604. The error counter is advanced in the operations 607, 608 if the determined checksum is not valid. If the checksum is valid, a flow rate of the ventilation fan 12 is calculated in an operation 609 from the data received in the operation 604. The received data and calculated flow rate are stored in an operation 610 and compiled into a data set 615. The error counter is reset in an operation 611, the indicators 21, 23, 25 of the output display module 24 are activated, for example blinked, in an operation 612, and an index counter is advanced in operations 613, 614. In the illustrative embodiment, data is collected for a predetermined number of cycles, as indicated by the index counter, and compiled into the data set 615 in operations 601-614. The indicators 21, 23, 25 of the output display module 24 are deactivated or turned off in an operation 616 and an average flow rate for the ventilation fan 12 is calculated from the data set 615 in an operation 617 after the predetermined number of data collection cycles. The calculated average is compared to a reference value 619 in an operation 618. In some embodiments, the reference value is based on applicable building codes and regulations, certification programs, and/or input by a user as detailed herein. An error signaling process 1000 is initiated if the calculated average flow rate from operation 617 is below the reference value 619. A data output process 700 is initiated if the calculated average flow rate from operation 617 is above the reference value 619.

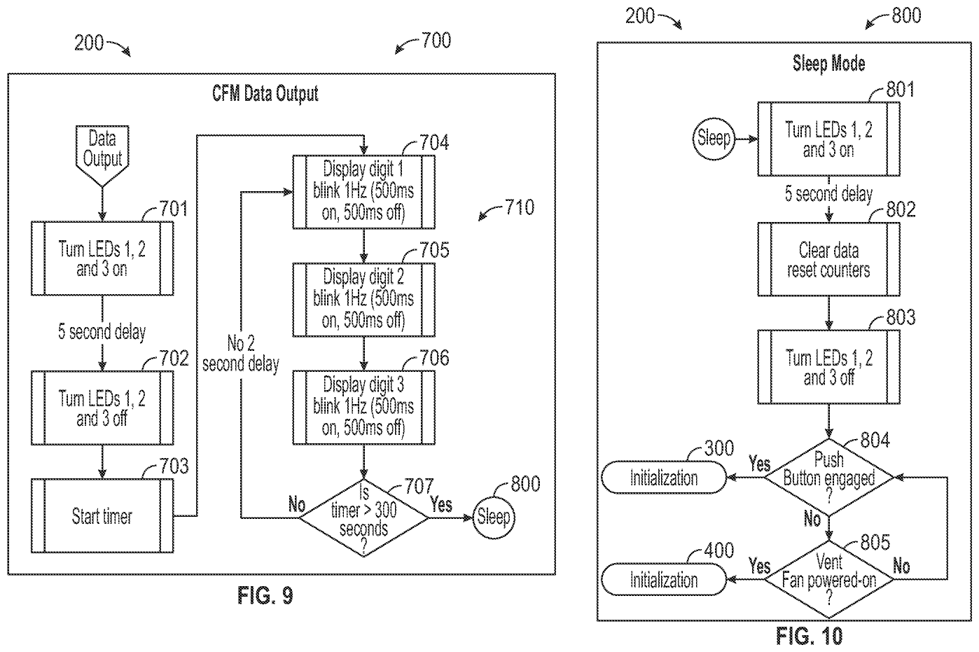

Referring to FIG. 9, an illustrative embodiment of the data output process 700 of the ventilations system operating process 200 is shown. The indicators 21, 23, 25 of the output display 24 are activated and then deactivated in operations 701, 702 with a short delay there between to signal to the User that a reading of the calculated flow rate for the ventilation fan 12 is about to be displayed. A timer is started in an operation 703 and then a display cycle 710 is initiated. The indicators 21, 23, 25, corresponding to the 100's, 10's, and 1's place for example, are activated or blinked in operations 704-706 to provide the signal to the User of the value of the flow rate as detailed herein. The display cycle 710 is repeated if the timer is below a predetermined level as determined in an operation 707. In the illustrative embodiment, a sleep process 800 (sometimes called a sleep mode) is initiated after the timer reaches the predetermined level. The system 10 is configured such that a visual effect (LED) emits out of the ventilation fan 12 in red or green to show achieved CFM or not. In some embodiments, the LED can be located on the motor user interface, on the back of the grille, or on a front of the grille. In some embodiments, the LED is powered by the motor user interface. In some embodiments a remote LED is used and wired for connection to the electronic test unit 14.

FIG. 10 shows an illustrative embodiment of the sleep process 800 of the ventilations system operating process 200. The indicators 21, 23, 25 are activated or turned on in an operation 801, all counters in process 200 are reset in an operation 802, and the indicators 21, 23, 25 are then deactivated or turned off in an operation 803. Sensing for initialization is conducted in operations 804, 805, and the sleep process 800 continues if initialization processes 300, 400 have not been initiated.

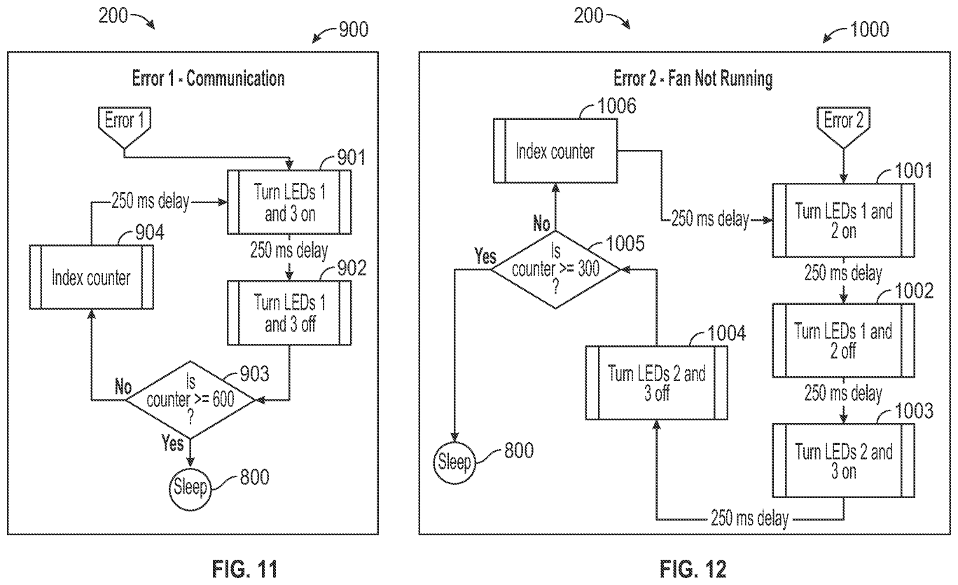

Referring to FIG. 11, an illustrative embodiment of the error signaling process 900 of the ventilations system operating process 200 is shown. In some embodiments, the error signaling process 900 operates to provide a signal to the User that communication between the test unit 14 and the ventilation fan 12 has failed or another error for diagnosis and correction by the user. In the illustrative embodiment, the indicators 21, 25 are repeatedly activated and then deactivated or turned on and off for a predetermined number of times in operations 901-904. The sleep process 800 is initiated after the predetermined number of cycles is completed.

FIG. 12 shows an illustrative embodiment of the error signaling process 1000 of the ventilations system operating process 200. In some embodiments, the error signaling process 1000 operates to provide a signal to the User that the ventilation fan 12 is not operating with the required flow rate as suggested in FIG. 8, where the required flow rate is specified by local and state statutes and used for certain home certification programs. In the illustrative embodiment, a first group of the indicators are activated and then deactivated, and then a second group of the indicators are activated and then deactivated, both occurring with a repeating patter over a period of time. For example, the indicators 21, 23 are turned on and off followed by the indicators 23, 25 being turned on and off in a repeating pattern for a predetermined number of times in operations 1001-1006 as suggested in FIG. 12. The sleep process 800 is initiated after the predetermined number of cycles is completed.

In illustrative embodiments, a ventilation system 10 includes an electronic test unit 14 that reads the RPM and current draw from a BLDC motor controller and generates a CFM reading through blinking LED lights for a user. The test unit 14 can determine CFM from readings of any BLDC motor, or motor controller that is driving a blower fan, regardless of the end product. The electronic test unit 14 includes a PCB board with MCU 31, UART connection 32, battery 34 with protection and regulation, and three LEDs 21, 23, 25. The PCB board connects to a BLDC motor/controller through the UART port 32 and communicates with the motor controller. Alternate communication protocols or interfaces could be used based on the application. Initiation of the electronic test unit 14 can be done by momentary toggle/push-button, toggle/push on/off switch, voltage sensing, or through command protocols. Upon initiation and request, the motor controller provides RPM and current draw to the MCU 31. The fan CFM is determined from the RPM and current draw of the motor. In some embodiments, the MCU 31 requires the motor to warm up before taking measurements and averages the readings. In some embodiments, each reading is verified with a checksum. An audible response with/without visual indicators can be provided, using beeps or voice to communicate CFM. Wired/wireless connections can be used between the motor, electronic test unit 14, and other devices.

In illustrative embodiments, the MCU 31 controls three LEDs 21, 23, 25 to display the resulting CFM; one LED for the (100)'s digit, one LED for the (10)'s digit and one LED for the (1)'s digit. The LEDs repeat this output for a specified duration after the measurement data collection is complete. The MCU 31 can react to the BLDC error codes and connection issues displaying a variety of error messages to the end user for troubleshooting. Visual feedback could alternatively be a built-in LCD, a seven-segment display, or LED array.

In illustrative embodiments, the system 10 of the present disclosure allows the installer to verify that the ventilation fan, such as a bathroom exhaust fan 12, is operating at the desired flow rate, which is dictated by local and state statutes and used for certain home certification programs such as Energy STAR 3.0 for Homes, LEED for Homes, CA Title 24, CalGreen, and other Green Building programs. The disclosed system 10 eliminates the need for specialized equipment to determine the flow rate of the ventilation fan, allows for corrections before inspection to minimize rework, and minimizes the need for repeat visits by inspectors to test the flow rate.

In illustrative embodiments, the disclosed system 10 allows the User to install the system 10 and take the measurements of the operating conditions of the ventilation fan 12 with the grille or guard installed, which enables a more accurate measurement of CFM flow in the intended application. In some embodiments, a delay in the start of taking measurements allows the User to install the grille or guard without needing to access or have a line of sight to the test unit 14 during operation. A visual indication of CFM is displayed and continues for an extended amount of time after the measurements are made to allow the grille or guard to be removed so the User has a clear line of sight to the determined CFM output. In some embodiments, the visual indication is visible through the grille or guard, which can be louvered. The electronic test unit 14 is low-cost and consumes minimal power when used, allowing it to be powered by a small battery. Having a power source on-board gives additional flexibility to the application of use, including being able to be used in applications where there is not sufficient onboard power to power the device. The LED output is simple, intuitive, and low cost. Using blinking LEDs to indicate error codes or operation modes makes the output familiar to most end users.

In illustrative embodiments, the systems of the present disclosure allow onboard testing of CFM output of the ventilation fan 12. The test follows an easy and simple test method and does not require costly or bulky external test equipment. A unique visual feedback system is provided. Verification of the fan output CFM before inspection for Energy STAR 3.0 for Homes, LEED for Homes, CA Title 24, CalGreen, and other Green Building programs, allows the installer to correct any problems before the inspection review of the building in which the ventilation fan 12 is installed. If a conventional ventilation fan fails to pass inspection, the installer will need to correct the problem and have the inspector come back. The earlier in the process the CFM can be verified, the less the impact is on re-work and re-inspection.

In illustrative embodiments, the electronic test unit 14 can include a mass airflow sensor. Also, the electronic test unit 14 can use a position of a damper flap to indicate air flow. In addition, the electronic test unit 14 includes a CFM reading display showing 2 or 3 numbers using Wi-Fi or UART port (MCU+LCD+EXT Power supply+cable). Also, the electronic test unit 14 includes a CFM reading display showing 2 or 3 numbers on a Motor User interface. In illustrative embodiments, the electronic test unit 14 plugs into the BLDC motor drive to receive motor operating data, and includes an extra power supply for a wireless module.

In illustrative embodiments, the camera of a smartphone 17 and integrated app could be used to measure the RPM of the ventilation fan 12 using a molded reflective surface on a rotating fan wheel of the ventilation fan. A reflective surface, such as a segment of tape, can be applied to or integrated with the blower wheel. The User then activates a strobe light tachometer app on a smartphone to calculate the flow rate based upon measured rotational speed (RPM) with the aid of an algorithm and/or reference table (e.g., fan curve lookup table).

Below is the Remote Motor Interface (RMI) Setup Protocol mentioned above:

1. Hardware
1.1 UART Serial Communication
   Baud Rate—9,600
   Parity—Odd
   Byte Size—8 bits
   Stop Bit—1 bit
1.2 Signal Interfaces
   RX (receive serial data)
   TX (transmit serial data)
   GND (ground reference)
1.3 Signal Levels
   3.3V Logic Levels
   Must be isolated from micro-processor
1.4 Connector
   Refer to Specification CN-2
1.5 Electrical/Environmental Requirements
   All other electrical/environmental requirements in the ERD Specifications.

2. Serial Protocol
2.1 Broan logic module is the bus master.
   BLDC controller responds based on request from the logic module (Never Fail module).
2.2 Power up and reset operation.
   When the BLDC controller is powered up, it will begin to monitor the UART RMI within 1000 milliseconds of power being applied to the BLDC controller.
2.3 Logic module (Never Fail module) sends a (4) bytes command string
   2.3.1 Byte 1: Command:
      0x01—Send Status
      0x02—Turn On
      0x03—Turn Off
      0x04—Set Speed
   2.3.2 Byte 2, 3: Data in RPM: range of 0 to 2,000 RPM (unsigned 16-bit integer)
      0x00, 0x00—When Byte 1 is NOT in set Speed.
      0xXX, 0xYY—(0xXXYY RPM in 16 bits)
   2.3.3 Byte 4: Checksum:
      0xZZ—ZZ is the checksum field is a sum of the bytes 1-4 in the command string, modulo 256.
2.4 BLDC controller responds with (10) byte status string
   2.4.1 Byte 1: Motor Identifier:
      0x01—Motor 1;
      0x02—Motor 2;
      0x03—Motor 3;
      0x04—Motor 4.
   2.4.2 Byte 2, 3: Motor Date Code:
      Byte 2: 0xYY—YY=last 2 digits of year
      Byte 3: 0xMM—MM=range Month 1-12
   2.4.3 Byte 4, 5: Firmware Revision: i.e. version 01.00=AA.BB
      0xAA—AA is the Major version
      0xBB—BB is the sub version
   2.4.4 Byte 6: Motor Status
      0x00—off;
      0x01—operating;
      0x1X—error code from 0x11 to 0x1F (ex: error code 1=0x11, error code 2=0x12)
   2.4.5 Byte 7, 8: Motor RPM: range of 0 to 2,000 RPM (unsigned 16-bit integer)
      0xXX, 0xYY—(0xXXYY RPM in 16 bits)
   2.4.6 Byte 9, 10: Motor Current: range of 0 to 1,000 mA (unsigned 16-bit integer)
      0xXX, 0xYY—(0xXXYY mA current in 16 bits)
   2.4.7 Byte 11: Checksum:
      0xZZ—ZZ is the checksum field is a sum of the bytes 1-10 in the status string, modulo 256.

While the present disclosure describes various exemplary embodiments, the disclosure is not so limited. To the contrary, the disclosure is intended to cover various modifications, uses, adaptations, and equivalent arrangements based on the principles disclosed. Further, this disclosure is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims. It should be understood that the illustrated embodiments are exemplary only, and should not be taken as limiting the scope of the disclosure.

Headings and subheadings, if any, are used for convenience only and are not limiting. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

1. A ventilation system that self-determines its operating characteristics to allow a user to assess compliance of the ventilation system with pre-determined performance standards, the ventilation system comprising:
a ventilation fan adapted to be installed to a support surface in a room of a building, the ventilation fan operable to draw air from the room to a discharge location external to the room; and
a test unit operatively coupled to the ventilation fan, wherein the test unit (i) measures operating characteristics of the ventilation fan to determine a flow rate of the ventilation fan, and (ii) provides a signal to the user regarding the determined flow rate in comparison to the performance standards.

2. The ventilation system of claim 1, wherein the test unit is operatively coupled to a motor of the ventilation fan, and wherein the test unit measures at least one of a rotational speed of the motor and a current draw of the motor during operation of the ventilation fan in order to determine the flow rate of the ventilation fan.

3. The ventilation system of claim 1, wherein the test unit is configured to provide at least one of a visual signal and an auditory signal regarding the determined flow rate of the ventilation fan.

4. The ventilation system of claim 3, wherein the test unit is configured to (i) produce light in a first visible color in response to the determined flow rate being above a threshold value of the performance standards and (ii) produce light in a second visible color in response to the determined flow rate being below the threshold value of the performance standards.

5. The ventilation system of claim 3, wherein the test unit is configured to produce light in a first visible color in response to the determined flow rate being above a threshold value of the performance standards.

6. The ventilation system of claim 5, wherein the test unit is configured to produce light in a second visible color in response to the determined flow rate being below the threshold value of the performance standards.

7. The ventilation system of claim 3, wherein the test unit has an output display module that visually indicates a numerical value of the determined flow rate of the ventilation fan to the user.

8. The ventilation system of claim 7, wherein the output display module of the test unit includes a plurality of indicators configured to produce visible light, wherein each indicator represents a digit of a numerical value, and wherein the test unit is configured to blink the indicators to visually indicate a numerical value of the determined flow rate of the ventilation fan to the user.

9. The ventilation system of claim 8, wherein the output display module is part of a circuit of the test unit, wherein the circuit further includes a microcontroller unit coupled to the output display module and operatively coupled to the motor of the ventilation fan, and wherein the microcontroller unit is configured to measure operating characteristics of the ventilation fan, determine a flow rate of the ventilation fan, and operate the output display module to provide the signal.

10. The ventilation system of claim 1, wherein the test unit provides an indication of an error in measuring the operating characteristics of the ventilation fan.

11. The ventilation system of claim 7, wherein the output display module of the test unit provides an indication of an error in determining flow rate of the ventilation fan.

12. The ventilation system of claim 1, wherein the test unit includes a plurality of indicators, and wherein the test unit provides a visual indication that the determined flow rate is below a threshold value of the performance standards by blinking the indicators in a predetermined pattern.

13. The ventilation system of claim 7, wherein the output display module of the test unit includes a plurality of indicators, and wherein the output display module provides a visual indication that the determined flow rate is below a threshold value of the performance standards by blinking the indicators in a predetermined pattern.

14. The ventilation system of claim 1, wherein the test unit includes a wireless transmitter and receiver to wirelessly connect with a mobile electronic device for display of the determined flow rate.

15. The ventilation system of claim 14, wherein the test unit transmits a pass signal via the wireless transmitter and receiver to the mobile electronic device when the determined flow rate exceeds a threshold value of the performance standards.

16. The ventilation system of claim 14, wherein the test unit transmits a fail signal via the wireless transmitter and receiver to the mobile electronic device when the determined flow rate falls below a threshold value of the performance standards.

17. The ventilation system of claim 1, further comprising a grille through which air is drawn during operation of the ventilation system and being positioned to underlie the ventilation fan, wherein the signal is visible by the user through the grille.

18. The ventilation system of claim 7, further comprising a grille through which air is drawn during operation of the ventilation system and being positioned to underlie the ventilation fan, wherein the numerical value of the determined flow rate of the ventilation fan to the user provided by the output display module is visible by the user through the grille.

19. The ventilation system of claim 1, wherein the test unit is initialized for measuring the operating characteristics of the ventilation fan in response to activation of the ventilation fan.

20. The ventilation system of claim 1, wherein the test unit includes a switch, and wherein the test unit is initialized for measuring the operating characteristics of the ventilation fan in response to activation of the switch.

21. The ventilation system of claim 1, wherein the test unit is configured (i) to gather multiple measurements of the operating characteristics of the ventilation fan and (ii) determine the flow rate of the ventilation fan based on an average of the multiple measurements of the operating characteristics.

22. A method for operating a ventilation system that self-determines its operating characteristics to allow a user to assess compliance of the ventilation system with pre-determined performance standards, the method comprising:
providing a ventilation fan having a test unit;
installing the ventilation fan to a support surface in a room of a building;
operating the ventilation fan to draw air from the room to a discharge location external to the room;
measuring operating characteristics of the ventilation fan with the test unit to determine a flow rate of the ventilation fan;
comparing the determined flow rate against a threshold value of the pre-determined performance standards with the test unit; and,
displaying a signal to the user of the ventilation system regarding the determined flow rate as compared to the threshold value of the pre-determined performance standards.

23. The method of claim 22, wherein the step of displaying a signal to the user further comprises:
displaying a first signal in response to the determined flow rate being above the threshold value and displaying a second signal in response to the determined flow rate being below the threshold value.

24. The method of claim 22, wherein the step of displaying a signal to the user further comprises:
displaying a first signal in response to the determined flow rate being above the threshold value by the test unit.

25. The method of claim 24, wherein the step of displaying a signal to the user further comprises:
displaying a second signal in response to the determined flow rate being below the threshold value by the test unit.

26. The method of claim 22, wherein the step of displaying the signal includes blinking a plurality of indicators by the test unit to visually indicate a numerical value of the flow rate to the user, wherein each indicator represents a digit of the numerical value.

27. The method of claim 22, wherein the test unit is operatively coupled to a motor of the ventilation fan, and wherein the test unit measures at least one of a rotational speed of the motor and a current draw of the motor during operation of the ventilation fan in order to determine the flow rate of the ventilation fan.

28. The method of claim 27, wherein the step of displaying a signal to the user further comprises:
the test unit displaying at least one of a visual signal and an auditory signal to the user regarding the determined flow rate as compared to the threshold value of the pre-determined performance standards.

29. The method of claim 22, wherein the test unit includes a wireless transmitter and receiver to wirelessly connect with a mobile electronic device of the user for display of the determined flow rate.

30. The method of claim 29, wherein the step of displaying a signal to the user further comprises:
the test unit transmitting a pass signal via the wireless transmitter and receiver to the mobile electronic device when the determined flow rate exceeds the threshold value of the performance standards.

31. The method of claim 30, wherein the step of displaying a signal to the user further comprises:
the test unit transmitting a fail signal via the wireless transmitter and receiver to the mobile electronic device when the determined flow rate falls below the threshold value of the performance standards.

32. The ventilation system of claim 1, wherein the step of measuring operating characteristics of the ventilation fan further comprises:
the test unit determining the flow rate of the ventilation fan based on an average of multiple measurements of the operating characteristics gathered by the test unit.
